(19) United States
(12) Patent Application Publication
(10) Pub. No.: US 2013/0005168 A1
(43) Pub. Date: Jan. 3, 2013

(54) ELECTRICAL CARD CONNECTOR

(75) Inventors: CHUN YE, Kunshan (CN); FANG-YUE ZHU, Kunshan (CN); QI-JUN ZHAO, Kunshan (CN)

(73) Assignee: HON HAI PRECISION INDUSTRY CO., LTD., New Taipei (TW)

(21) Appl. No.: 13/537,071

(22) Filed: Jun. 29, 2012

(30) Foreign Application Priority Data
Jun. 29, 2011 (CN) 201120224921.8
Jul. 1, 2011 (CN) 201120228346.9

(51) Int. Cl. H01R 13/62

(52) U.S. Cl. 439/159

(57) ABSTRACT

An electrical card connector (100) includes an insulative housing (1), a plurality of contacts (2) and an ejector (3) assembled to the insulative housing (1). The insulative housing (1) defines an inserting slot (15) and an inserting opening (150) in front of the inserting slot (15). The ejector (3) includes a limiting block (34) movable between a first position and a second position. When the limiting block (34) is at the first position, the limiting block (34) covers the inserting opening (150) to prevent an electrical card (300) from moving forwardly. When the limiting block (34) is at the second position, the inserting opening (150) is fully exposed to exterior for the electrical card (300) could be inserted into the inserting slot (15) or withdraw from the inserting slot (15). The electrical card connector (100) could be used by one single hand and would be operated conveniently for user.

### BACKGROUND OF THE INVENTION

1. Field of the Invention

The present invention generally relates to an electrical card connector and more particularly to an electrical card connector having a limiting block for positioning the electrical card reliably and securely within the connector.

2. Description of Related Art

U.S. Pat. No. 7,252,522 discloses an electrical card connector including an insulative housing, a plurality of contacts retained in the insulative housing and an ejector assembling to one side of the insulative housing. The insulative housing has an inserting cavity and an inserting port in front of the inserting slot. The electrical connector has a positioning portion assembling to one side of the insulative housing, a post, a limiting block movable along a left to right direction and an elastic member surrounding the post. The limiting block covers the inserting port in a first position. When the electrical card is inserted into the electrical card connector, user pushes the limiting block outside by one hand against the elastic member. Then, user inserts the electrical card into the inserting cavity by the other hand. Finally, user releases the limiting block, the elastic member pushes the limiting block back to the first position and the limiting block abuts against a front of the electrical card to prevent the electrical card from moving forwardly. When the electrical card is ejected from the electrical card, user removes the limiting block and press the limiting block by one hand. Then, user ejectors the electrical card out of the inserting cavity by the other hand. The electrical card connector is operated by two hands and is not conveniently for users.

Other objects, advantages and novel features of the present invention will become more apparent from the following detailed description of the present embodiment when taken in conjunction with the accompanying drawings.

### SUMMARY OF THE INVENTION

The present invention provides an electrical card connector comprises an insulative housing, a plurality of contacts retained in the insulative housing and an ejector. The insulative housing has an inserting slot and an inserting opening in front of the inserting slot. The ejector has a slider assembled movable in the insulative housing, a spring pressing between the insulative housing and the slider and a guiding post assembling to the insulative housing and the slider, the ejector further has a limiting block movable between a first position and a second position, when the limiting block is at the first position, the limiting block covering the inserting opening, when the limiting block is at the second position, the inserting opening is fully exposed to exterior.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical card connector according to a preferred embodiment of the present invention, showing an electrical card inserted in the electrical card connector;

FIG. 2 is another perspective view of the electrical card connector;

FIG. 3 is a partially exploded, perspective view of the electrical card connector as shown in FIG. 2;

FIG. 4 an exploded, perspective view of the electrical card connector as shown in FIG. 2;

FIG. 5 is a perspective view of the electrical card connector, showing the electrical card inserted in the electrical card connector and the limiting block being at a second position;

FIG. 6 is a top perspective view of the electrical card connector, showing an electrical card completely received inserted in the electrical card connector and the limiting block returning a first position;

FIG. 7 is a partially exploded view of a slider of the electrical card connector shown in FIG. 4;

FIG. 8 is a perspective view of an electrical card connector according to a second embodiment of the present invention;

FIG. 9 is similar to FIG. 8, while taken from a different aspect;

FIG. 10 is a partially exploded view of a slider of the electrical card connector shown in FIG. 8;

FIG. 11 is a perspective view of an electrical card connector according to a third embodiment the present invention;

FIG. 12 is an enlarged view of a part of the electrical card connector shown in FIG. 11, showing a limiting block is at first position;

FIG. 13 is similar with FIG. 12, showing the limiting block is at second position;

### DETAILED DESCRIPTION OF THE INVENTION

Reference will now be made to the drawing figures to describe the preferred embodiment of the present invention in detail.

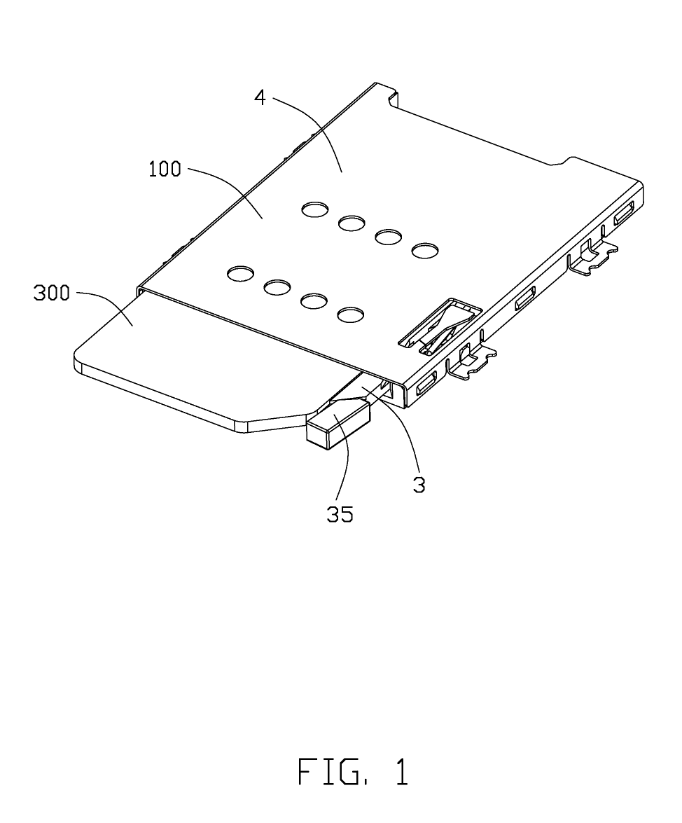

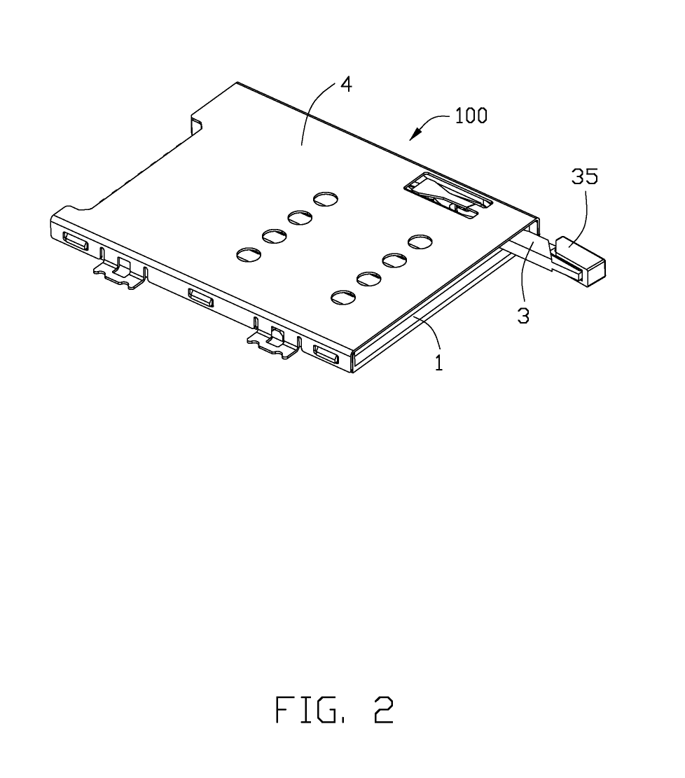

Referring to FIGS. 1-3, an electrical card connector 100 is used for soldering to a printed circuit board (not labeled) and receiving an electrical card 300. The electrical card connector 100 includes an insulative housing 1, a plurality of contacts 2 received in the insulative housing 1, an ejector 3 assembled to the insulative housing 1 and a metal shell 4.

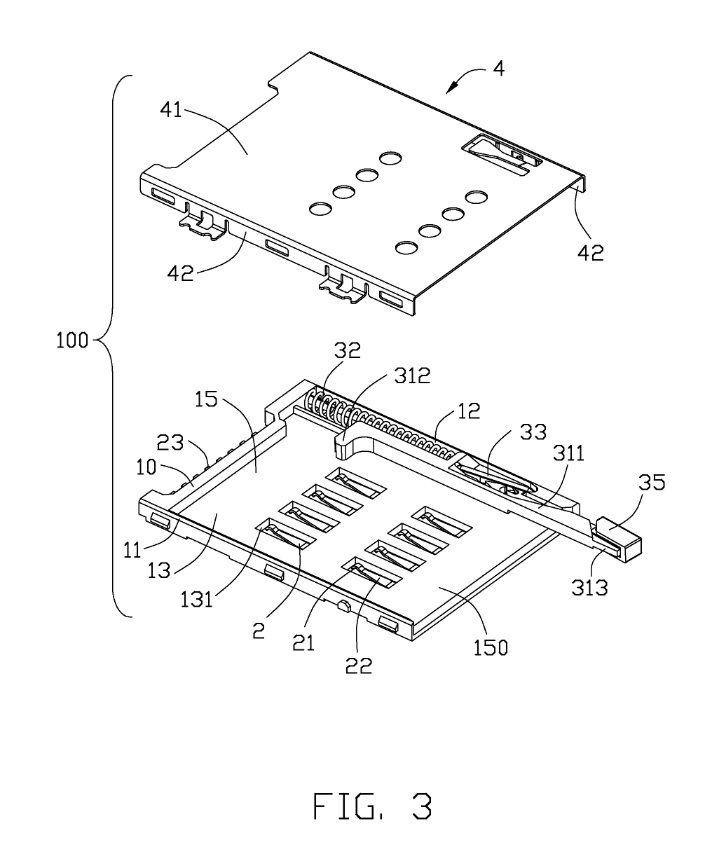

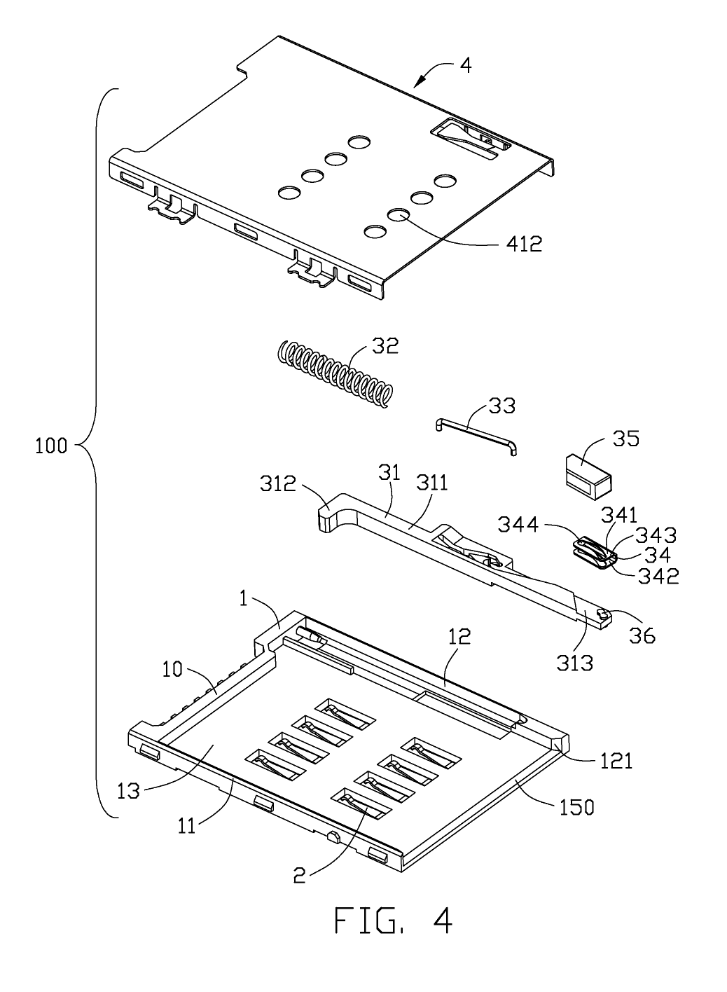

Referring to FIGS. 3-4, the insulative housing 1 includes a rear wall 10, a left portion 11, a right portion 12, a bottom wall 13 connecting the left and right portions 11, 12 and the rear wall 10 and an inserting slot 15 defined by the rear wall 10, the left and right portions 11, 12 and the bottom wall 13. The inserting slot 15 has an inserting opening 150 located in a front thereof. The inserting slot 15 is used for receiving the electrical card 300. The right portion 12 has an inclining face 121 extending into the inserting slot 15 from a front thereof. The bottom wall 13 has a plurality of passageways 131 passing therethrough along a top-to-bottom direction.

The contacts 2 are used for connecting with the electrical 300. The contacts 2 each include a retaining portion (not labeled) integrally molded in the bottom wall 13, an extending portion 22 extending into the passageway 131 from the retaining portion, a contacting portion 21 extending into the inserting slot 15 upwardly from the extending portion 22 and a soldering portion 23 extending backwardly from the retaining portion and outside of the rear wall 10 of the insulative housing 1.

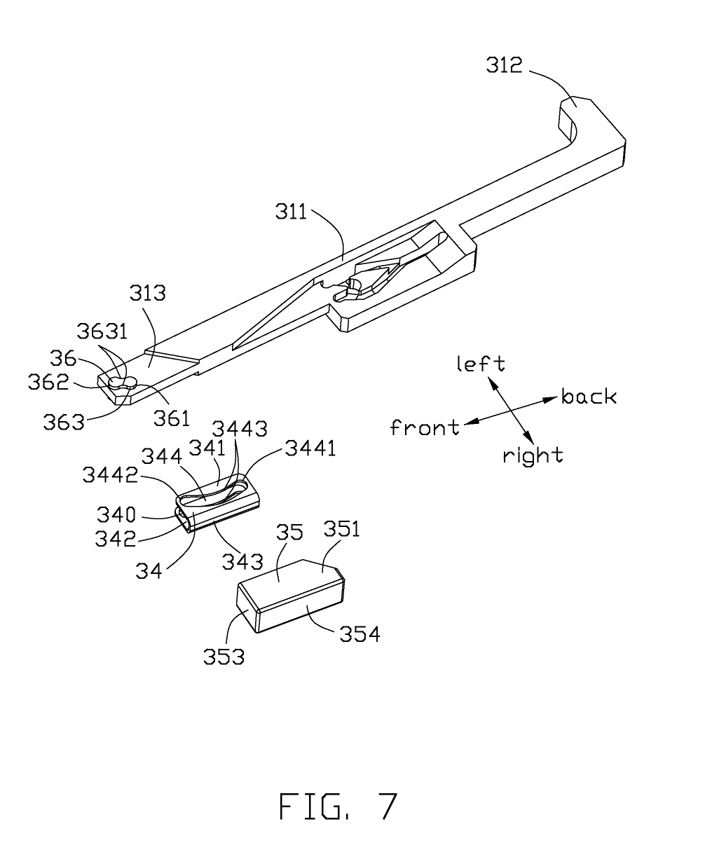

Referring to FIGS. 4-7, the ejector 3 is assembled in the right portion 12. The ejector 3 has a slider 31 moving along a front-to-back direction, a spring 32 disposed between the insulative housing 1 and the slider 31, a guiding post 33 assembling to the insulative housing 1 and the slider 31, a metal limiting block 34 located in a front of the slider 31 and an insulative cover 35 covered the limiting block 34. The slider 31 includes a guiding portion 311 received in the inserting slot 15, a positioning portion 312 extending into the inserting slot 15 and vertically from a rear of the guiding portion 311 and a leading portion 313 extending forwardly from the guiding portion 311. The leading portion 313 is thinner than the guiding portion 311. The leading portion 313 has two convexes 36 extending upwardly and downwardly from a top and a bottom faces of a front thereof. The convexes 36 extend backwardly and aslant from the front of the leading portion 313. The convexes each include a rear face 361, a front face 362 and two end faces 363 connecting the front face 362 and rear face 361. The rear face 361 has a semi-circle shape and protrudes backwardly. The front face 362 also has a semi-circle shape and protrudes forwardly. The end faces 363 each has two slots 3631 located in a middle thereof. When the slider 31 locates in an initial position, the front of the leading portion 313 forwardly extends beyond the inserting slot 15.

The limiting block 34 is made by a metal plate. The limiting block 34 has a top plate 341, a bottom plate 342 and a connecting wall 343 connecting the top plate 341 and the bottom plate 342. A retaining space 340 is formed between the top plate 341 and the bottom plate 342. The top plate 341 and the bottom plate 342 each have a guiding slot 344 passing therethrough and has an arc-shaped configuration. The guiding slots 344 extend from a left and front direction of the top and bottom plates 341, 342 to a right and back direction toward the connecting wall 343 and then extend to a left and back direction. Each of the top plate 341 and the bottom plate 342 has a rear edge 3441, a front edge 3442 and two lateral edges 3443 linking the front edge 3442 to the rear edge 3441, these edges 3441, 3442, 3443 surround. A length between the front and rear edges 3442, 3441 is longer than a width of the guiding slot 344 of the limiting block 34 to prevent the limiting block 34 from rotating in the leading portion 313 excessively. The guiding slot 344 defines a semi-circle outline at a front and a rear end thereof corresponding to the front face 362 and the rear face 361. The leading portion 313 is received in the retaining space 340 of the limiting block 34 and the convex 36 protrudes into the guiding slot 344. The lateral edges 3443 of the guiding slot 344 abut against the end faces 363 of the convex 36, the front face 362 can abut against the front edge 3442 and the rear face 361 can abut against the rear edge 3441. When the limiting block 34 is assembled to the leading portion 313, the limiting block 34 is lower than a top face of the guiding portion 311. When the rear face 361 abuts against the guiding slot 344, the limiting block 34 locates in a first position and covers a part of the inserting opening 150. When the front face 362 abuts against the guiding slot 344, the limiting block 34 locates in a second position and the limiting block 34 is disposed outside the inserting opening 150 outside.

The insulative cover 35 has an upper shielding wall 351, a lower shielding wall 352, a front shielding wall 353, an outside shielding wall 354 and a receiving space 350 formed by the upper shielding wall 351, the lower shielding wall 352, the front shielding wall 353 and the outside shielding wall 354. The limiting block 34 is received in the receiving space 350 to prevent the top plate 341 and bottom plate 342 disengaging from the leading portion 313 and prevent the limiting block 34 from corroding. When the cover 35 wraps the limiting block 34, a height of the cover 35 is same as that of the guiding portion 311.

The metal shell 4 has a top wall 41 covering the inserting slot 15 and two side wall 42 extending backwardly and vertically from two sides of the top wall 41, the top wall 41 has a plurality of openings 412 corresponding with the contacts 2. The side walls 42 are latched with the left and right portion 11, 12 of the insulative housing 1.

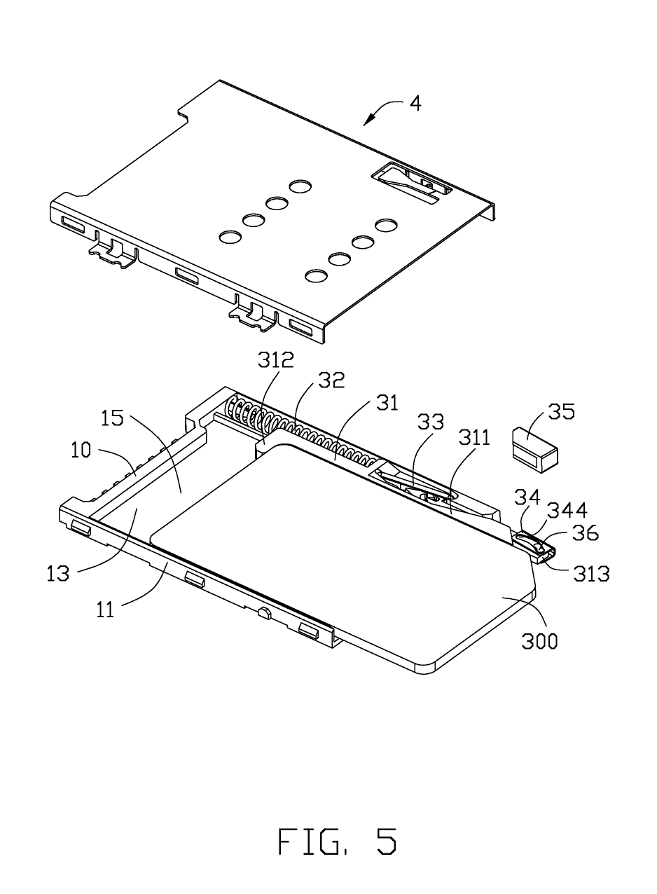

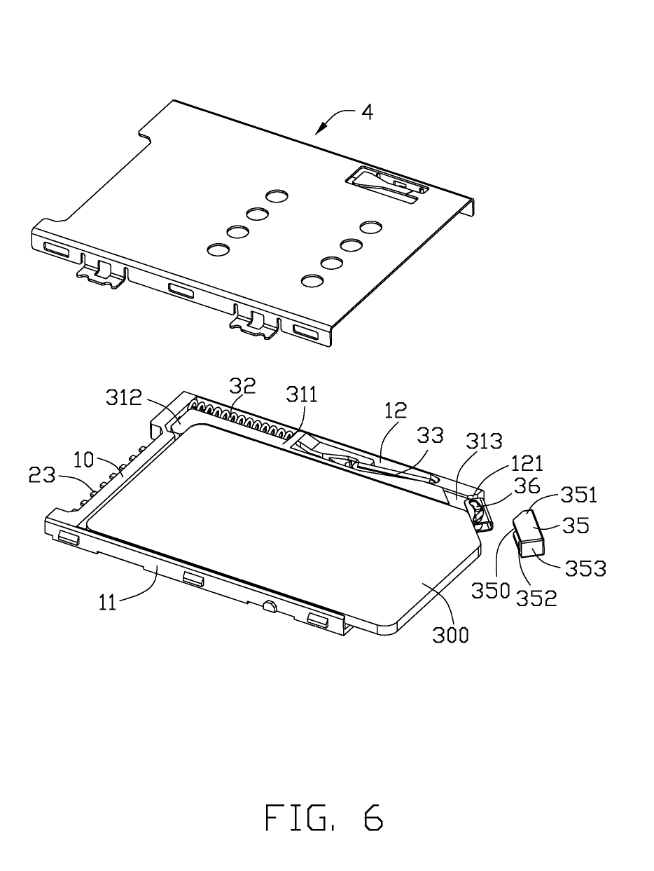

Referring to FIGS. 5-6, when the electrical card 200 is inserted into the electrical card connector 100, the slider 31 is in the initial position. The limiting block 34 is at the second position, the front face 362 abut against the front edge 3442, the electrical card 300 inserts into the inserting slot 15 from the inserting opening 150, abuts against the positioning portion 312. Then, user pulls the limiting block 34 forwardly by finger until the limiting block 34 arrives the first position, at this position, the limiting block 34 abuts against a front of the electrical card 300 to prevent the electrical card 300 from moving forwardly. Finally, the electrical card 300 and the shielder 31 are further pushed into the inserting slot 15 backwardly. The guiding portion 311 is received in the inserting slot 15 completely and the cover 35 and the limiting block 34 is received in the inserting slot 15 partly. The limiting block 34 abuts against the inclining face 121 backwardly to avoid the limiting block 34 to move backwardly.

When the electrical card 300 is ejected from the electrical card 100, the spring 32 pushes the slider 31 forwardly, the positioning portion 312 take the electrical card 300 outside of the inserting slot 15. Then, users push the limiting portion 314 backwardly by finger until the limiting block 34 moves to the second position. Finally, user pulls the electrical card 300 from the electrical card 100 by hand.

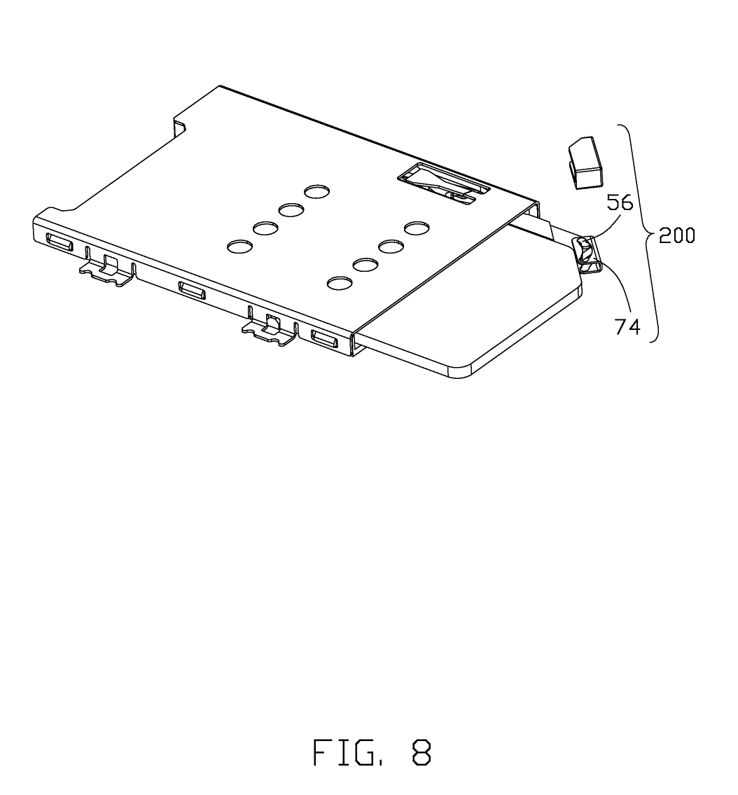

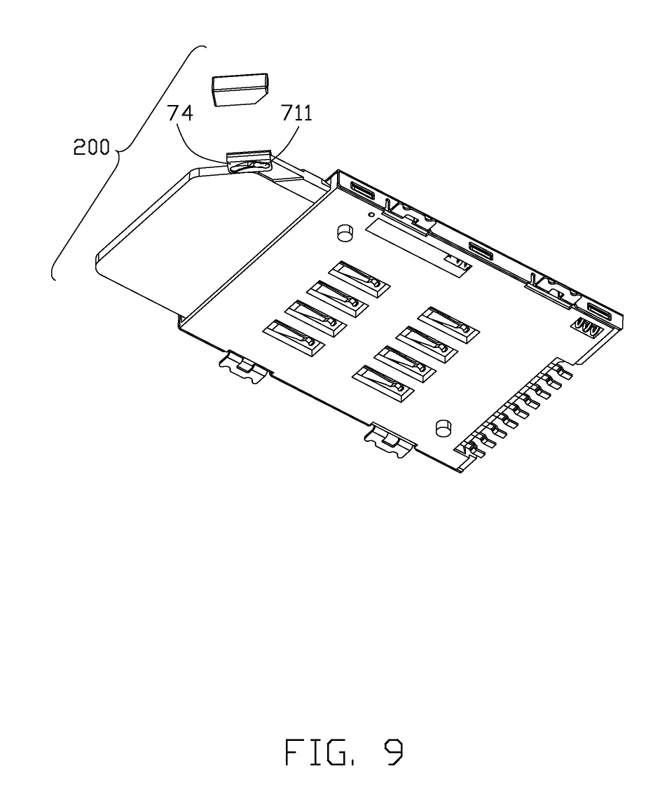

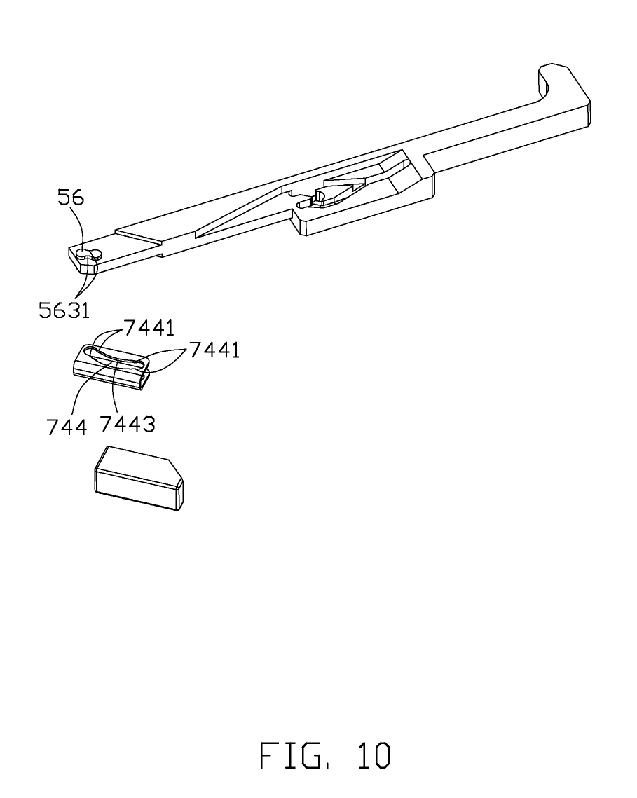

Referring to FIGS. 8-10, an electrical card connector 200 in accordance with a second embodiment of present invention is disclosed. The electrical card connector 200 is approximately similar to the electrical card connector 100 in the first embodiment, and the only difference is that: the guiding slot 744 of the limiting block 74 has a plurality of tabs 7441 located in the inside of the lateral edge 7443. When the limiting block 74 moves backwardly, the tabs 7411 in a front of the guiding slot 744 latched with the slot 5631 to retain the limiting block 74 retaining in the convex 56 reliably.

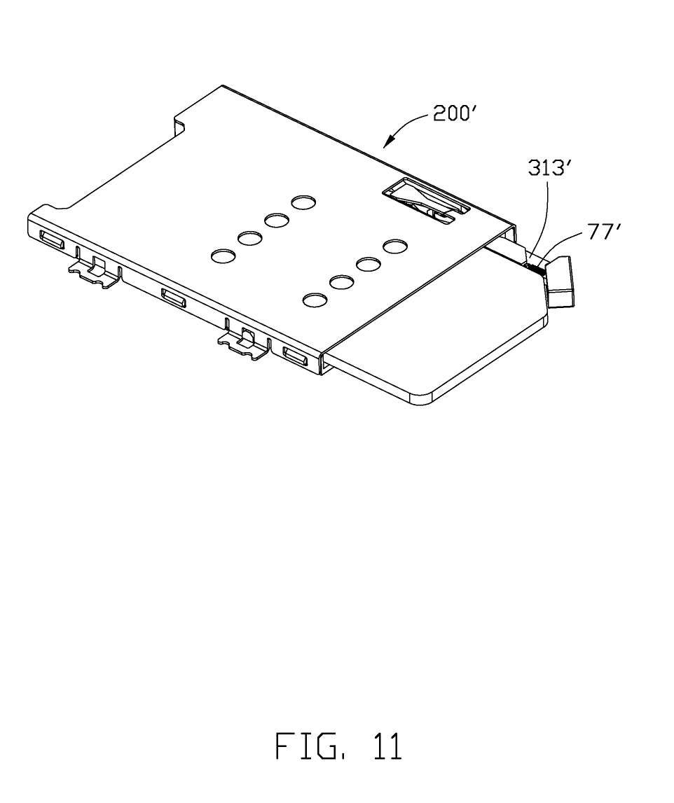

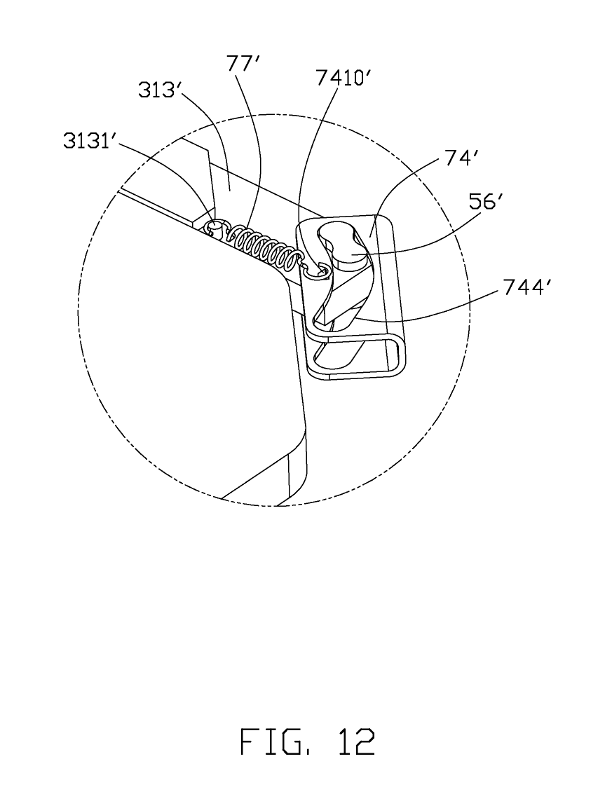

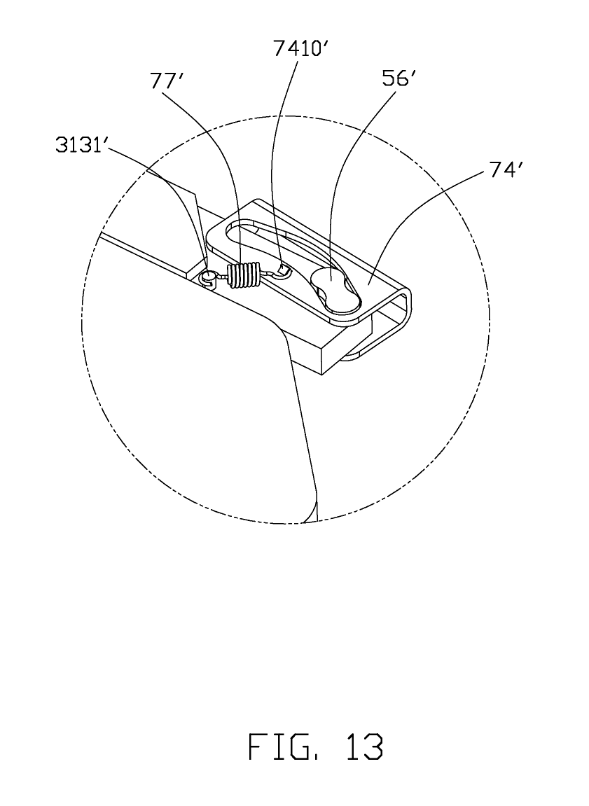

Referring to FIGS. 11-13, an electrical card connector 200′ for receiving an electrical card in a third embodiment is disclosed. The electrical card connector 200′ in the third embodiment is approximately similar to the electrical card connector 100 in the first embodiment, and the difference is that: the leading portion 313′ has a block post 3131′ located in a rear end thereof. The block post 3131′ is located in the left and rear direction of the convex 56′. The limiting block 74′ has a locking barb 7410′ at a middle of the guiding slot 744′. An elastic member 77′ disposed between the leading portion 313′ and the limiting block 74′. One end of the elastic member 77′ latches with the block post 3131′ and the other end of the elastic member 77′ latches with the locking barb 7410′. When the limiting block 74′ moves forwardly beyond a half of the guiding slot 744′, the elastic member 77′ pulls the limiting block 74′ backwardly to prevent the limiting block 74′ from moving along a clockwise. When the limiting block 74′ moves beyond the locking barb 7410′, the elastic member 77′ can pull the limiting block 74′ back to the first position.

The electrical card connectors 100/200/200′ has a limiting block 34, 74,74′ assembled in the front of the slider 31 to prevent the electrical card 300 from fling out of the electrical connector 100/200/200′ in work time and the electrical card connector 100, 200, 200′ could be used by one single hand and be operated conveniently for user.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical card connector, adapted for receiving an electrical card comprising:
an insulative housing having an inserting slot with an inserting opening in front of the inserting slot;
a plurality of contacts retained in the insulative housing; and
an ejector having a slider assembled to the insulative housing and being movable in the insulative housing, a spring disposed between the insulative housing and the slider and a guiding post assembled to the insulative housing and the slider to control a movement of the slider, the ejector further having a limiting block attached to the slider and moving between a first position relative to the slider and a second position along a front-to-back direction, when the limiting block is at the first position, the limiting block covering the inserting opening, when the limiting block is at the second position, the inserting opening fully exposed to exterior, the first position and the second position offsetting along both the front-to-back direction and a right-to-left direction.

2. The electrical card connector as claimed in claim 1, wherein the limiting block has a top plate, a bottom plate and a connecting wall connecting the top plate and the bottom plate, a retaining space formed between the top plate and the bottom plate, a front of the slider is received in the retaining space.

3. The electrical card connector as claimed in claim 2, wherein the slider has a guiding portion, a positioning portion extending into the inserting slot and a leading portion extending forwardly from the guiding portion, the leading portion is received in the retaining space of the limiting block, the leading portion is thinner than the guiding portion, the leading portion has at least one convex extending upwardly and downwardly from a top and a bottom faces thereof to guide the limiting block to move along.

4. The electrical card connector as claimed in claim 3, wherein the top plate and the bottom plate each have a guiding slot, the guiding slot extends from a left and front direction to a right and back direction and then extends to a left and back direction, the convex is received in the guiding slot, when the limiting block is assembled to the leading portion, the limiting block is lower than a top face of the guiding portion.

5. The electrical card connector as claimed in claim 4, wherein the convex has a front face, a rear face and two end faces connecting the front and rear faces, two end faces each define a slot in a middle thereof, the front face has a semi-circle shape and protrudes forwardly, the rear face also has a semi-circle shape and protrudes backwardly, the limiting block has a front edge and a rear edge around the guiding slot, the guiding slot defines a semi-circle outline at a front and a rear ends thereof corresponding to the front face and the rear face of the convex, when the limiting block is at the second position, the front face abuts against the front edge, when the limiting block is at the first position, the rear face abuts against the rear edge.

6. The electrical card connector as claimed in claim 5, wherein a length of the guiding slot along a front to back direction is longer than a width of the guiding slot.

7. The electrical card connector as claimed in claim 5, wherein when the limiting block moves inwardly and forwardly till the convex abuts against the rear edge, that is also the first position of the limiting block, the limiting block abuts against a front of the electrical card to prevent an electrical card from moving forwardly, the limiting block moves outwardly and backwardly till the convex abuts against the front edge, that is the second position of the limiting block, the inserting opening is fully exposed to exterior.

8. The electrical card connector as claimed in claim 3, further comprising an insulative cover covering the limiting block, the cover has an upper shielding wall, a lower shielding wall and an outside shielding wall connecting the upper shielding wall and the lower shielding wall, a receiving space is defined by the upper shielding wall, the lower shielding wall and the outside shielding wall, the limiting block is received in the receiving space and the height of the cover is same as that of the guiding portion.

9. The electrical card connector as claimed in claim 8, wherein the insulative housing has a rear wall, a left portion, a right portion and a bottom wall, the right portion has an inclining face extending into the inserting slot, the cover and the limiting block are received in the inserting slot partly and abut against the inclining face.

10. The electrical card connector as claimed in claim 5, wherein the guiding slot also has two lateral edges connecting the front edge and the rear edge, the lateral edges each has a plurality of tabs latching with the slots.

11. The electrical card connector as claimed in claim 4, wherein the leading portion has a block post located in a back thereof, The limiting block has a locking barb located near the guiding slot, the electrical connector has an elastic member, one end of the elastic member latching with the block post and the other end of the elastic member latching with the locking barb.

12. An electrical card connector, adapter for receiving an electrical card comprising:
an insulative housing having an inserting slot and an inserting opening in front of the inserting slot;
a plurality of contacts retained in the insulative housing; and
an ejector having a slider assembled to the insulative housing and being movable in the insulative housing, a spring disposed between the insulative housing and the slider and a guiding post assembling to the insulative housing and the slider, the ejector further having a limiting block movable linked to the slider, one of the limiting block and the slider defining a guiding slot and the other having a convex sliding within the guiding slot, so that the limiting block can slide on the slider and block or expose the inserting opening.

13. The electrical card connector as claimed in claim 12, further comprising an elastic member, one end of the elastic member contacts to the slider and the other end of the elastic member is connects the limiting block.

14. The electrical card connector as claimed in claim 12, wherein the slider has a block post, the limiting block has a locking barb located in a left side of the guiding slot, one end of the elastic member latching with the block post and another end of the elastic member latching with the locking barb.

15. The electrical card connector as claimed in claim 14, wherein the slider has a guiding portion, a positioning portion extending into the inserting slot and a leading portion extending forwardly from the guiding portion, the leading portion is received in the limiting block, the leading portion is thinner than the guiding portion, the leading portion has at least a convex extending upwardly and downwardly from at least one of a top and a bottom faces of thereof and guiding the limiting block to move along.

16. The electrical card connector as claimed in claim 15, wherein the limiting portion has at least one guiding slot, the guiding slot extends from a left and front direction to a right and back direction and then extends to a left and back direction, the convex is received in the guiding slot, when the limiting block is assembled to the leading portion, the limiting block is lower than a top face of the guiding portion.

17. An electrical card connector for use with an electronic card, comprising:
an insulative housing cooperating with a metallic shell to commonly define a card receiving space therebetween in a vertical direction for receiving said electronic card;
a plurality of contacts disposed in the housing with contacting sections exposed into the card receiving space;
an ejector assembled to the housing,
said ejector including a slider back and forth movable with regard to the housing along a front-to-back direction perpendicular to said vertical direction, and a block moveably attached to a rear end section of the slider; wherein
said block defines an imaginary pivot with regard to the rear end section and said pivot is moveable relative to the rear end section in both said front-to-back direction and a transverse direction, which is perpendicular to both said front-to-back direction and said vertical direction, so as to allow the block for compliantly abutting against a corresponding position of a rear edge of said electronic card for locking.

18. The electrical card connector as claimed in claim 17, wherein said block is moveable relative to the slider between a free position, where is laterally and outwardly away from the receiving space, and a locking position, where is blocking movement of the electronic card with regard to the card receiving space.

19. The electrical card connector as claimed in claim 18, wherein the locking position is oblique to the front-to-back direction and said transverse direction.

20. The electrical card connector as claimed in claim 17, wherein said rear end section and said block are configured with a curved groove to allow the block to move relative to the rear end section in a curved manner.
